(19) United States
(12) Patent Application Publication
(10) Pub. No.: US 2024/0220217 A1
(43) Pub. Date: Jul. 4, 2024

(54) SYSTEM AND METHOD FOR PROVIDING A CUSTOMIZED LAYOUT FOR PRESENTING INFORMATION FROM DIFFERENT APPLICATIONS IN AN INTEGRATED MANNER

(71) Applicant: RAKUTEN SYMPHONY SINGAPORE PTE. LTD., Singapore (SG)

(72) Inventors: Yuumi HORI, Tokyo (JP); Sanyam MADAAN, Tokyo (JP); Tomoya MURATA, Tokyo (JP); Rina TAKAMATSU, Tokyo (JP); Dhanesh AWATE, Tokyo (JP)

(73) Assignee: RAKUTEN SYMPHONY SINGAPORE PTE. LTD., Singapore (SG)

(21) Appl. No.: 17/918,831

(22) PCT Filed: Jul. 27, 2022
(86) PCT No.: PCT/US2022/038424

§ 371 Date: Oct. 13, 2022

(51) Int. Cl. G06F 8/38; G06F 3/0482; G06F 3/04845; G06F 3/0486

(52) U.S. Cl. CPC G06F 8/38; G06F 3/0482; G06F 3/04845; G06F 3/0486

(57) ABSTRACT

A method of providing a customized layout in an integrated presentation system. The method includes, outputting a list including a plurality of components in a first region of a layout builder screen, each of the plurality of components corresponding to one of a plurality of applications, based on receiving a component selection input including one or more components, among the plurality of components, from the list, displaying the one or more components in one or more areas in a second region of the layout builder screen, creating the customized layout based on the one or more components in the one or more areas in the second region of the layout builder screen and mapping the customized layout with one or more roles, among a plurality of roles associated with a user of the integrated presentation system.

### BACKGROUND

### 1. Field

The disclosure relates to a system and a method for providing a customized layout for presenting information from different applications in an integrated manner.

### 2. Description of the Related Art

Multiple applications may be hosted and deployed in a particular ecosystem (or system), such as a cloud platform for an enterprise or business in various industries, for providing various services to customers. For example, in telecommunication industry, a customer may contact a customer agent of the enterprise or business with a query or a question regarding issues related to services provided by the enterprise or the business. In this case, the customer agent needs to answer the customer's query or resolve the issues raised by the customer quickly and efficiently to satisfy the customer.

In a related art system in an industry, such as a telecom industry, an agent would have to review various customer information, such as, network usage, billing, and device point of view, in order to answer the customer's query or resolve the issues raised by the customer. In such a system, the various customer information may be retrieved from different data sources (e.g., different third party vendors) and displayed on a screen of a user terminal operated by the agent.

However, the agents may have different roles or skills, and since the related art systems provide the same customer information to the agent without taking the agent's roles into consideration, unnecessary and irrelevant information may be presented to the agent. For example, a billing agent having a billing role, which requires dealing with billing inquiries from a customer, may not need to see information related to customer's data usage or customer's social media data. Hence, the related art systems, which provide or show unnecessary or unneeded information on a screen of an agent's terminal, may not only cause excessive steps that would lead to unnecessary delays in operation by the agent, but such systems require increased computer resources (i.e., processors and memories) to fetch, process and store the unnecessary/unneeded data.

### SUMMARY

According to one or more embodiments, systems and methods are provided that allows agents to access and retrieve customer information in real-time and user-friendly manner based on a role or skill associated with the agent by integrating information from multiple data sources in one view. As such, systems and methods of the disclosure may retrieve and provide information based on the role of an agent, thus avoiding excessive operations, unnecessary operational and network delays and reduced use of computer resources such as processor and memory capacity.

According to an aspect of the disclosure, there is provided a method of providing a customized layout in an integrated presentation system, the method including: outputting a list including a plurality of components in a first region of a layout builder screen, each of the plurality of components corresponding to one of a plurality of applications; based on receiving a component selection input including one or more components, among the plurality of components, from the list, displaying the one or more components in one or more areas in a second region of the layout builder screen; creating the customized layout based on the one or more components in the one or more areas in the second region of the layout builder screen; and mapping the customized layout with one or more roles, among a plurality of roles associated with a user of the integrated presentation system.

The component selection input may include at least one of dragging the one or more components from the first region and dropping the one or more components into the second region, changing a size of the one or more components, by dragging an edge of the one or more components, or moving the one or more components within the second region.

The receiving the component selection input including the one or more components may include: receiving a first selection including a first component, among the plurality of components from the list, the first component configured to display first data from a first application, among the plurality of applications; and receiving a second selection including a second component, among the plurality of components from the list, the second component configured to display second data from a second application, among the plurality of applications.

The displaying the one or more components may include: displaying the first component in a first area in the second region of the layout builder screen; and displaying the second component in a second area in the second region of the layout builder screen.

The method may further include receiving a category selection input indicating a category corresponding to an application platform, among a plurality of categories of application platform; and outputting the list including the plurality of components based on the category selection input.

The method may further include publishing the customized layout to deploy the customized layout on the application platform.

According to another aspect of the disclosure there is provided an apparatus for providing a customized layout in an integrated presentation system, the apparatus may include: a memory storing instructions; and at least one processor configured to execute the instructions to: output a list including a plurality of components in a first region of a layout builder screen, each of the plurality of components corresponding to one of a plurality of applications; based on receiving a component selection input including one or more components, among the plurality of components, from the list, display the one or more components in one or more areas in a second region of the layout builder screen; create the customized layout based on the one or more components in the one or more areas in the second region of the layout builder screen; and map the customized layout with one or more roles, among a plurality of roles associated with a user of the integrated presentation system.

The component selection input may include at least one of dragging the one or more components from the first region and dropping the one or more components into the second region, changing a size of the one or more components, by dragging an edge of the one or more components, or moving the one or more components within the second region.

The processor may be further configured to: receive a first selection including a first component, among the plurality of components from the list, the first component configured to display first data from a first application, among the plurality of applications; and receive a second selection including a second component, among the plurality of components from the list, the second component configured to display second data from a second application, among the plurality of applications.

The processor may be further configured to display the first component in a first area in the second region of the layout builder screen; and display the second component in a second area in the second region of the layout builder screen.

The processor may be further configured to receive a category selection input indicating a category corresponding to an application platform, among a plurality of categories of application platform; and output the list including the plurality of components based on the category selection input.

The processor may be further configured to publish the customized layout to deploy the customized layout on the application platform.

According to another aspect of the disclosure there is provided a non-transitory computer readable medium having stored thereon a program from performing a method of providing a customized layout in an integrated presentation system, the method including: outputting a list including a plurality of components in a first region of a layout builder screen, each of the plurality of components corresponding to one of a plurality of applications; based on receiving a component selection input including one or more components, among the plurality of components, from the list, displaying the one or more components in one or more areas in a second region of the layout builder screen; creating the customized layout based on the one or more components in the one or more areas in the second region of the layout builder screen; and mapping the customized layout with one or more roles, among a plurality of roles associated with a user of the integrated presentation system.

According to another aspect of the disclosure there is provided a method of providing information for a user in an integrated presentation system, the method including: receiving user identification information from an operator of an integrated presentation system; controlling, based on a role associated with the operator, to output a customized graphical user interface (GUI) to present information related to the user identification information; sending a plurality of parameters to a server, the plurality of parameters including first information corresponding to a first application, second information corresponding to a second application, and third information corresponding to one or more identifying parameters from the user identification information; receiving first data associated with the user identification information from the first application and second data associated with the user identification information from the second application; and controlling to output the first data and the second data in the GUI in an integrated manner based on the role associated with the operator.

According to another aspect of the disclosure there is provided an apparatus for providing information for a user in an integrated presentation system, the apparatus including: a memory storing instructions; and at least one processor configured to execute the instructions to: receive user identification information from an operator of an integrated presentation system; control, based on a role associated with the operator, to output a customized graphical user interface (GUI) to present information related to the user identification information; send a plurality of parameters to a server, the plurality of parameters including first information corresponding to a first application, second information corresponding to a second application, and third information corresponding to one or more identifying parameters from the user identification information; receive first data associated with the user identification information from the first application and second data associated with the user identification information from the second application; and control to output the first data and the second data in the GUI in an integrated manner based on the role associated with the operator.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 is a flowchart of an example process of providing a customized layout for presenting information from different applications in an integrated manner on a platform, according to an example embodiment;

FIG. 2 is a diagram of an example environment in which systems and/or methods, described herein, may be implemented;

FIG. 3 is a diagram of example components of a device according to an example embodiment;

FIG. 4 is a flowchart of an example process for providing information from different applications to be presented in an integrated manner, according to an example embodiment;

FIGS. 5A-5G illustrate a method of creating a customized layout according to example embodiments;

FIG. 6 is a flowchart of an example process for creating a customized layout, according to an example embodiment;

FIG. 7 is a flowchart of an example process for editing a published layout, according to an example embodiment; and

FIG. 8A illustrates an example of a default layout for presenting information, and FIGS. 8B and 8C illustrate examples of customized layout for presenting information, according to an example embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the disclosure provide a method and system in which global variables are defined in a platform and set for the automatic transfer of values thereof from one open screen of an application to another open screen of a different application. As a result, human error and time cost in inputting information to user input fields of an application interface is eliminated. Further, by directly transferring the information between open application screens, there is no need to connect to a backend database, thereby conserving network resources and bandwidth.

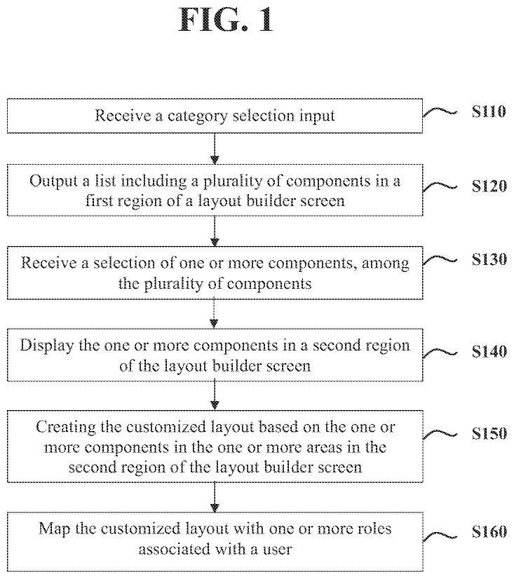

FIG. 1 is a flowchart of an example process building a layout for presenting information from different applications in an integrated manner on a platform, according to an example embodiment. Here, the platform may refer to an application platform that hosts, communicates with and/or deploys a plurality of applications. For example, the application platform may be a cloud platform including one or more servers in which the one or more applications are deployed. In this case, the application platform may be a cloud platform for a particular business or enterprise in which applications are deployed for use by employees and/or customers of the business (e.g., applications for day-to-day operations of the business, processing or inputting sales information, communicating with customers, troubleshooting, etc.). Further, the platform and applications therein may be built, hosted, and deployed in accordance with a microservices architecture. The applications in the application platform are configured to output or expose data. According to an example embodiment, the application platform may be built to communicate with various applications. According to an example embodiment, the various applications may be applications deployed on external servers. According to an example embodiment, the various applications may be third party applications deployed on external servers.

According to an example embodiment, the process of building a layout may include launching a layout builder application. The layout builder application may be an application of the application platform for the particular business or enterprise in which a customized layout may be created for use by the employees and/or the customers of the business. According to an example embodiment, an administrator of the application platform and/or the business enterprise may the layout builder application to create a customized layout. However, the disclosure is not limited thereto, and as such, according to another example embodiment, a user other than an administrator may be capable of launching the layout builder. For example, an a customer agent of the enterprise or business may launch the layout builder.

Referring to FIG. 1, at operation S110, a category selection input may be received by the layout builder application. According to an example embodiment, the administrator may select a layout category, from among a plurality of layout categories. According to an example embodiment, the layout categories may identify layouts for different types of application platforms. For instance, a first layout category of the layout categories may indicate a B2B application platform for business to business (B2B) application platform and a second layout category of the layout categories may indicate a B2C application platform for business to customer (B2C) application platform. However, the disclosure is not limited to B2B and B2C application platforms, and as such, other categories may indicate layouts of other application platform supported by the business enterprise.

According to an example embodiment, at operation S120, a list including a plurality of components may be output in a first region of a layout builder screen. According to an example embodiment, each of the plurality of components may corresponding to one of a plurality of applications of the application platform identified by the category in the category selection input at operation S110. For example, when the category selection input is a first category corresponding to a B2B application platform, a plurality of components corresponding to the B2B application platform may be output. On the other hand, when the category selection input is a second category corresponding to a B2C application platform, a plurality of components corresponding to the B2C application platform may be output. According to an example embodiment, the list or the plurality of components may be considered as a library of components corresponding to the selected category of application platform.

According to an example embodiment, each of the plurality of components corresponding to the B2B application platform may be application corresponding to the B2B application platform. On the other hand, each of the plurality of components corresponding to the B2C application platform may be application corresponding to the B2C application platform.

According to an example embodiment, at operation S130, the layout builder application may receive a component selection input from the plurality of components in the list. According to an example embodiment, the component selection input may include a selection of one or more components from the plurality of components. According to an example embodiment, at operation S140, based on receiving the component selection input including the one or more components, among the plurality of components, from the list, the layout builder application may display the one or more components in one or more areas in a second region of the layout builder screen.

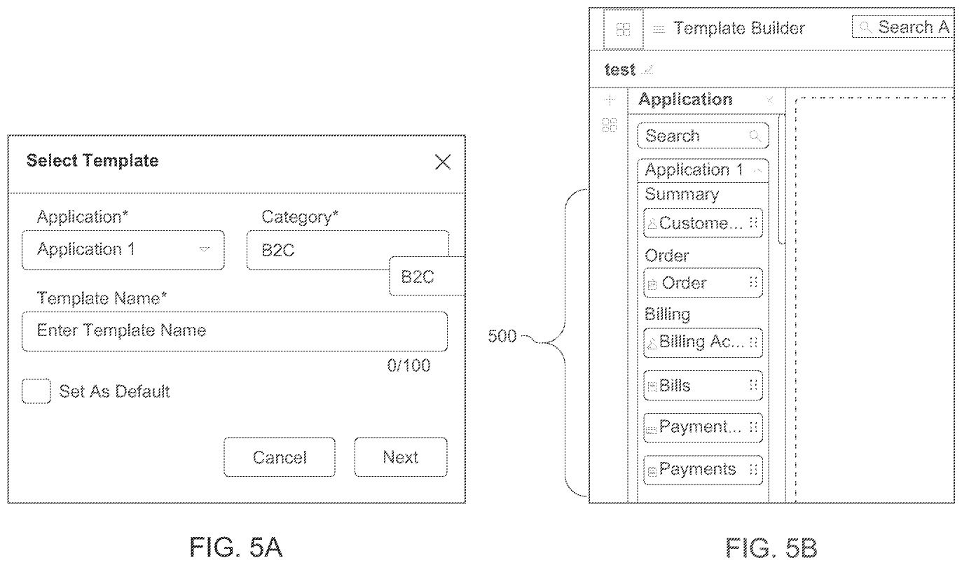

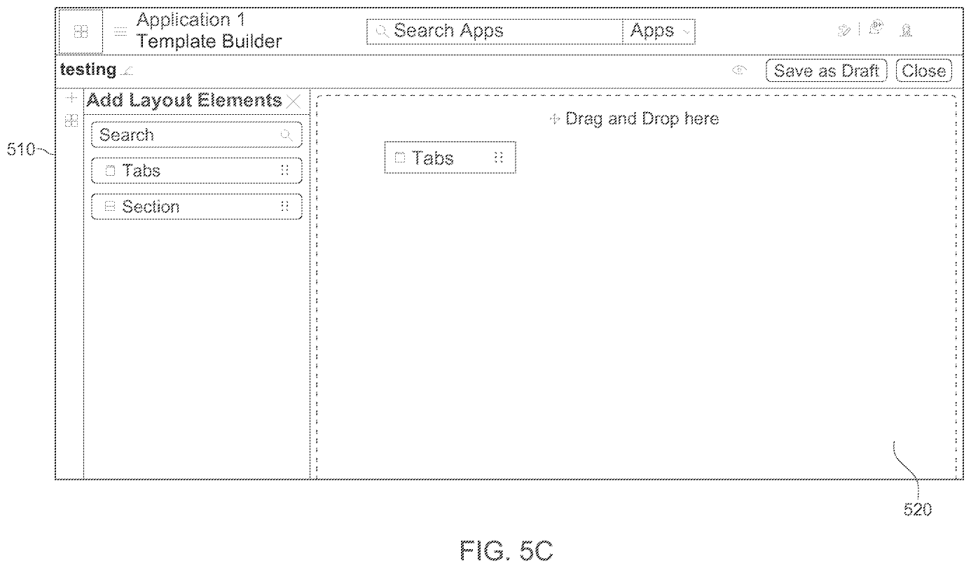

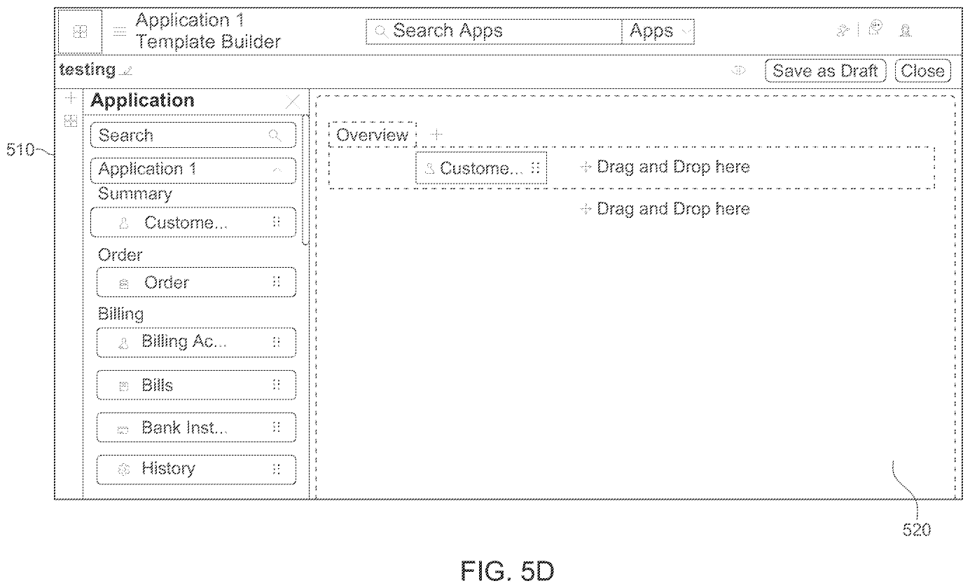

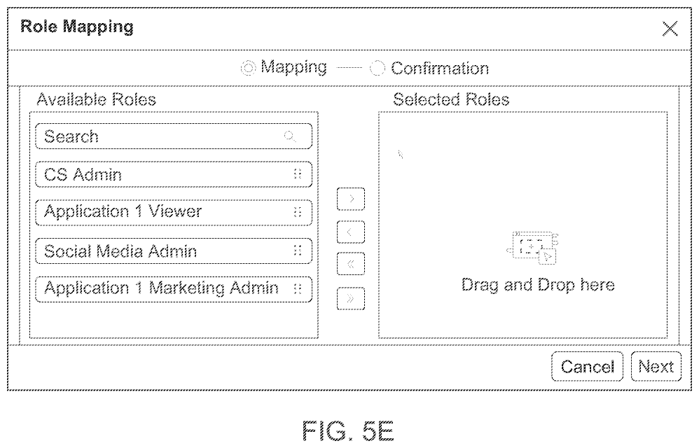

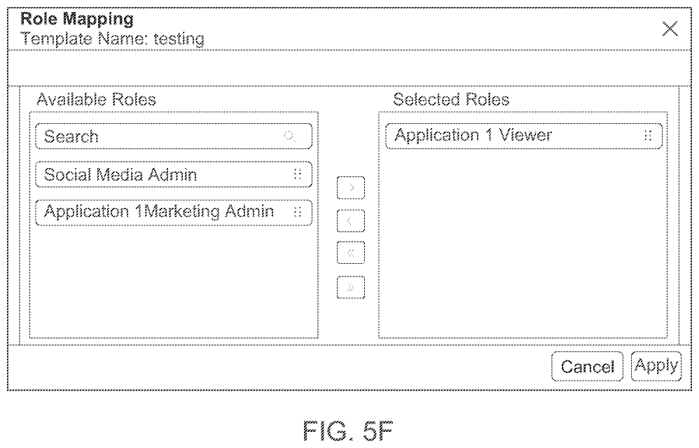

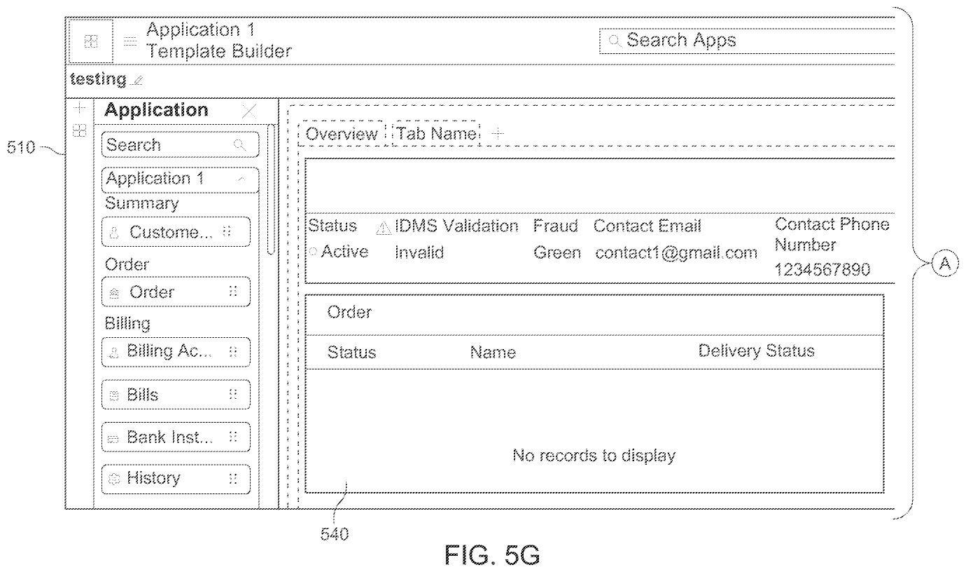

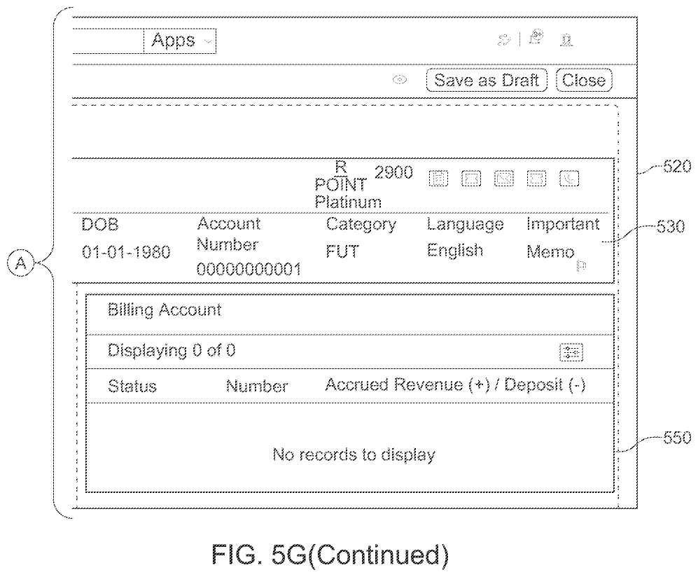

According to an example embodiment, the component selection input may include a user of the layout builder application selecting a component in the list provided in a first region of the layout builder application to be placed in a second region of the layout builder application. For example, the list of components may be provided on a left side of the layout builder screen as shown in FIGS. 5B and 5C.

According to an example embodiment, the user may drag and drop the selected component from the first region into the second region of the layout builder screen. For example, the selected components may be dragged and dropped into the right side of the layout builder screen as shown in FIGS. 5B and 5C. However, the disclosure is not limited thereto, and as such, according to another example embodiment, the components selected by the user may be automatically populated in the second region without required the user to drag and drop the selected component in the second region.

According to another example embodiment, one or more characteristics of the selected components provided in the second region may be customized by the user. For example, the user may change a size of the one or more components, move the one or more components within the second region or rearrange the one or more components in the second region. According to an example embodiment, the user may change the size of a component by clicking on an edge of the image (or icon) depicting the component and dragging the edge to enlarge and shrink the size of the image of the component. According to an example embodiment, the one or more components provided in the second region is various formats. For example, some components may be provided in a tab format, and other components may be provided in a tree format. However, the disclosure is not limited thererto, and as such, the one or more components may be customized in a different manner without departing from the scope of the disclosure.

According to an example embodiment, the layout builder application may receive a first selection including a first component, among the plurality of components from the list. Here, the first component may be a component configured to display first data from a first application, among the plurality of applications. Moreover, the layout builder application may receive a second selection including a second component, among the plurality of components from the list. Here, the second component may be configured to display second data from a second application, among the plurality of applications. According to an example embodiment, the first data and the second data may corresponding to a first service and a second service respectively, instead of the first application and the second application.

According to an example embodiment, the first data and the second data maybe fetched from external data sources corresponding to the first application and the second application. According to an example embodiment, the different applications and/or services may include external third party vendors or internal applications in the platform. According to an example embodiment, the first data may be fetched or retrieved from a first data source associated with the first application, and the second data may be fetched or retrieved from a second data source associated with the second application. According to an example embodiment, the first application may be a billing application for managing billing information of a customer, and the second application may be a data usage application for managing data usage information of a customer.

According to an example embodiment, when the first data and the second data is retrieved, the first data may be displayed in a first area at which the first component is provided in the customized layout screen and the second data may be displayed in a second area at which the second component is provided in the customized layout screen. Accordingly, the first data and the second data may be output and displayed in a single pane window including the first data and the second data in an integrated manner. According to an example embodiment, the first data and the second data may be displayed in a tiled, side-by-side, or non-overlapping manner. Further, the first data and second data may both be displayed within a same tab of a browser window. In an example embodiment where the second and third applications are deployed in a microservices architecture, the first data and second data may be micro frontends, e.g., of a same microservices domain (a model in which clusters of different data entities and processes correspond to or control a particular and significant area of functionality).

According to an example embodiment, at operation S150, the layout builder application may create customized layout graphical user interface based on the one or more components in the one or more areas in the second region of the layout builder screen. According to an example embodiment, creating the customized layout graphical user interface may include exporting and/or saving the arrangement of the one or more components in the second region of the layout builder screen as a layout for deployment, when a user launches an application or an executable file to run the customized layout. For example, the arrangement of the one or more components in the second region of the layout builder screen may be saved and/or exported as an HyperText Markup Language (HTML) file, and as such, can be executed as a web application. Moreover, in order to fetch the various data from different data sources, back end configuration may be provided to the customized layout. For example, APIs (Application Programming Interface) may be provided to the one or more components to facilitate back end configurations, such as communicating with authentication servers and/or external data sources to fetch relevant data to be displayed on the customized layout.

According to an example embodiment, at operation S160, the layout builder application may map the customized layout with one or more roles, among a plurality of roles. According to an example embodiment, a role may assigned to an agent or a user. According to an example embodiment, the role may be assigned to the agent of the business enterprise by an administrator based on the tasks assigned to the agent. For example, an agent, who is a billing specialist may be assigned billing role, whereas an agent, who is a social media specialist may be assigned a social media role.

According to an example, by mapping the map the customized layout with one or more roles, when an agent executes an application for providing service to a customer, a customized layout for viewing the customer information may be displayed based on the role of the agent matching the role mapped to the customized layout at operation S160. According to an example embodiment, the application may identify a role assigned to the agent and search for a customized layout, which is mapped with a role that matches the role of the agent. For instance, a role of the agent may be compared with the role of the customized layout to determine the customized layout best suited for the agent based on the role assigned to the agent.

Moreover, according to an example embodiment, the layout builder application may publish the customized layout to deploy the customized layout on the application platform. According to an example embodiment, when the customized layout is unpublished, the customized layout is not available for use by the agents or the users. However, when the customized layout is published, the customized layout is available for use by the agents or the users, and such, a customized layout may be provided based on the role of the agents or the users. That is, if a created customized layout is unpublished, it means that the customized layout not deployed in the application platform, and as such, none of the agents or the users can actually view or use the customized layout. However, if the created customized layout is published, it means that the customized layout is deployed in the application platform, and as such, the agents or the users who have roles matching the roles mapped to the customized layout can view or use the customized layout.

Although the description above illustrates a role being mapped to the customized layout, the disclosure is not limited thereto, and as such, according to another example embodiment, the customized layout may be mapped to a skill level of the user. Moreover, according to another example embodiment, a user may be able to create a customize layout according to the preference of th user.

According to the example embodiment illustrated in FIG. 1, compared to the related art systems, which provides the same various customer information without taking the agents roles into consideration, unnecessary and irrelevant information may be presented to the agent, the customized layout provides information in a manner that omits unnecessary or unneeded information, which not only reduces unnecessary delays in operation by the agent, but also reduces computer resources (i.e., processors and memories) to fetch, process and store the unnecessary/unneeded data. Thus, the example embodiment illustrated in FIG. 1 improves the overall functioning of the computer system.

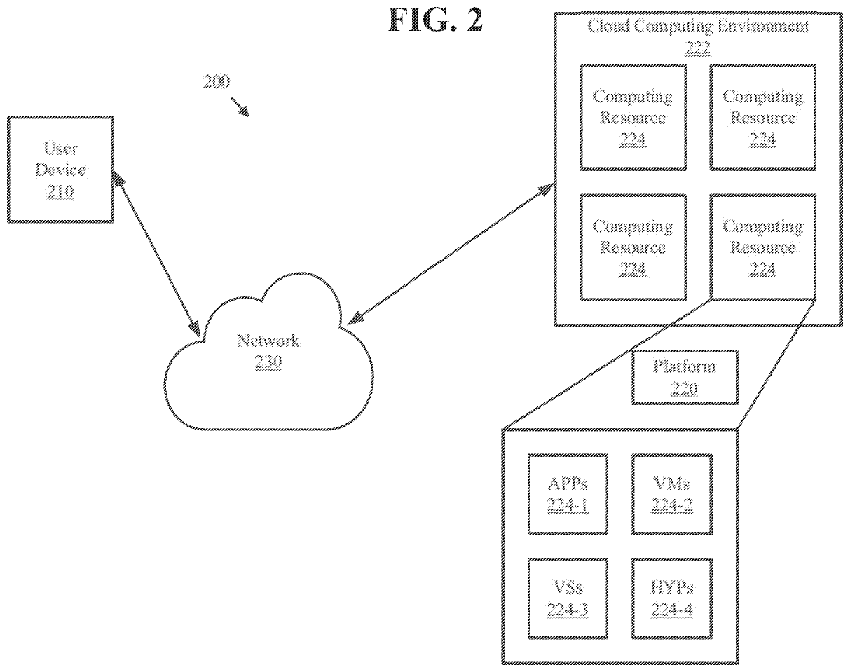

FIG. 2 is a diagram of an example environment 200 in which systems and/or methods, described herein, may be implemented. As shown in FIG. 2, environment 200 may include a user device 210, a platform 220, and a network 230. Devices of environment 200 may interconnect via wired connections, wireless connections, or a combination of wired and wireless connections. In embodiments, any of the functions and operations described with reference to FIG. 1 above may be performed by any combination of elements illustrated in FIG. 2.

User device 210 includes one or more devices capable of receiving, generating, storing, processing, and/or providing information associated with platform 220. For example, user device 210 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 210 may receive information from and/or transmit information to platform 220.

Platform 220 includes one or more devices capable of receiving, generating, storing, processing, and/or providing information. In some implementations, platform 220 may include a cloud server or a group of cloud servers. In some implementations, platform 220 may be designed to be modular such that certain software components may be swapped in or out depending on a particular need. As such, platform 220 may be easily and/or quickly reconfigured for different uses.

In some implementations, as shown, platform 220 may be hosted in cloud computing environment 222. Notably, while implementations described herein describe platform 220 as being hosted in cloud computing environment 222, in some implementations, platform 220 may not be cloud-based (i.e., may be implemented outside of a cloud computing environment) or may be partially cloud-based.

Cloud computing environment 222 includes an environment that hosts platform 220. Cloud computing environment 222 may provide computation, software, data access, storage, etc. services that do not require end-user (e.g., user device 210) knowledge of a physical location and configuration of system(s) and/or device(s) that hosts platform 220. As shown, cloud computing environment 222 may include a group of computing resources 224 (referred to collectively as “computing resources 224” and individually as “computing resource 224”).

Computing resource 224 includes one or more personal computers, a cluster of computing devices, workstation computers, server devices, or other types of computation and/or communication devices. In some implementations, computing resource 224 may host platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, or the like.

Application 224-1 includes one or more software applications that may be provided to or accessed by user device 210. Application 224-1 may eliminate a need to install and execute the software applications on user device 210. For example, application 224-1 may include software associated with platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program, and may support a single process. In some implementations, virtual machine 224-2 may execute on behalf of a user (e.g., user device 210), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems, and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

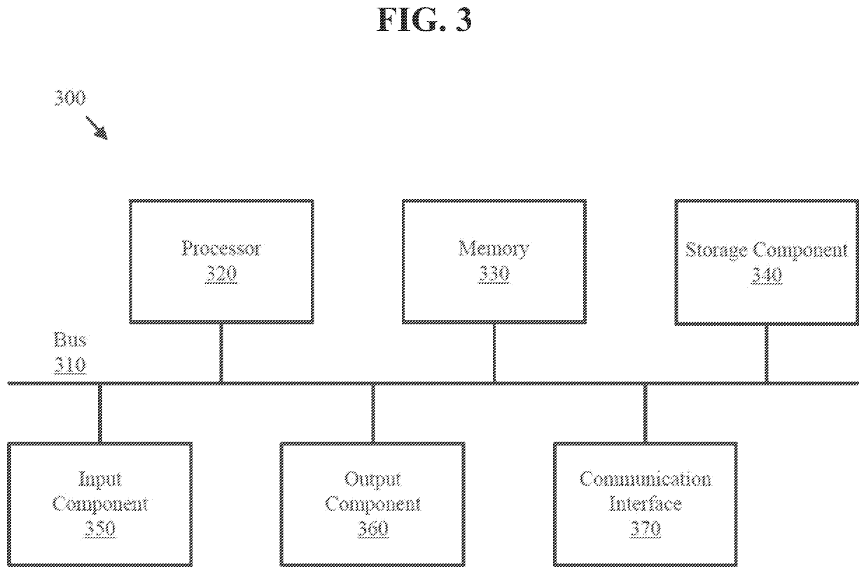

FIG. 3 is a diagram of example components of a device 300. Device 300 may correspond to user device 210 and/or platform 220. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 may be implemented in hardware, firmware, or a combination of hardware and software. Processor 320 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

According to example embodiments, any one of the operations or processes of FIG. 1 may be implemented by or using any one of the elements illustrated in FIGS. 2-3.

For example, according to an example embodiment, the device 300 may provide a customized layout in an integrated presentation system. The device 300 may include a memory 330 configured to store one or more instructions, and at least one processor 320 configured to execute the one or more instructions to output a list including a plurality of components in a first region of a layout builder screen, each of the plurality of components corresponding to one of a plurality of applications, based on receiving a component selection input including one or more components, among the plurality of components, from the list, display the one or more components in one or more areas in a second region of the layout builder screen, create the customized layout based on the one or more components in the one or more areas in the second region of the layout builder screen and map the customized layout with one or more roles, among a plurality of roles associated with a user of the integrated presentation system.

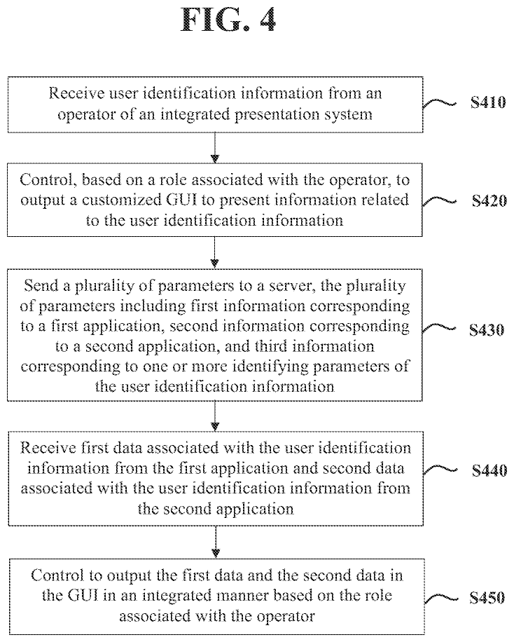

FIG. 4 is a flowchart of an example process for fetching information from different applications to be presented in an integrated manner, according to an example embodiment. For example, the method shown in FIG. 4 may correspond to operations that occur after the customized layout has been created, assigned a role and published (or deployed) for use.

Referring to FIG. 4, in operation S410, an application running at a terminal of an operator (i.e., a user or an agent) may receive user identification information from the operator. According to an example embodiment, the user identification information may identify a customer, who has contacted the business enterprise with an inquiry related to the business provided by the business enterprise. According to an example embodiment, when the customer contacts the business enterprise with inquiry, the customer may be routed to an operator or an agent with a role based qualified to answer the inquiry. For example, if the customer contacts the business enterprise with an inquiry about a billing issue, the customer may be routed to an operator or an agent, whose role is to deal with billing issues. However, the disclosure is not limited thereto, and as such, the customer call may be routed based on various different roles to other operators matching the role.

According to an example embodiment, at operation S420, the application running at the terminal of the operator may control, based on a role associated with the operator, to output a customized graphical user interface (GUI) to present information related to the user identification information. For instance, based on the role associated with the operator, a customized layout as created in FIG. 1, may be displayed on a display at the terminal of the operator.

According to an example embodiment, at operation S430, the application running at the terminal of the operator may send a plurality of parameters to a server, the plurality of parameters including first information corresponding to a first application, second information corresponding to a second application, and third information corresponding to one or more identifying parameters of the user identification information. According to an example embodiment, the server may be a gateway server, which receives the plurality of parameters from the application running at the terminal of the operator.

According to an example embodiment, at operation S440, the application running at the terminal of the operator may receive first data associated with the user identification information from the first application and second data associated with the user identification information from the second application. Moreover, at operation S450, the application running at the terminal of the operator may control to output the first data and the second data in the GUI in an integrated manner based on the role associated with the operator. For instance, based on the role associated with the operator, a customized layout as created in FIG. 1, may be displayed on the display at the terminal of the operator to present the first data and the second data.

According to an example embodiment, a screen of the application can automatically obtain and input values for customer information fields directly from vendor or third party servers. As a result, according to an example embodiment, the application may not have to store the customer information in a local database, thereby conserving resources and maintaining security and privacy.

According to example embodiments, any one of the operations or processes of FIG. 4 may be implemented by or using any one of the elements illustrated in FIGS. 2-3.

For example, according to an example embodiment, the device 300 may provide information for a user in an integrated presentation system. The device 300 may include a memory 330 configured to store one or more instructions, and at least one processor 320 configured to execute the one or more instructions to receive user identification information from an operator of an integrated presentation system, control, based on a role associated with the operator, to output a customized graphical user interface (GUI) to present information related to the user identification information, send a plurality of parameters to a server, the plurality of parameters including first information corresponding to a first application, second information corresponding to a second application, and third information corresponding to one or more identifying parameters from the user identification information, receive first data associated with the user identification information from the first application and second data associated with the user identification information from the second application and control to output the first data and the second data in the GUI in an integrated manner based on the role associated with the operator.

FIGS. 5A-5G illustrate a method of creating a customized layout according to example embodiments. According to an example embodiment, the illustrations in FIGS. 5A-5G may corresponding to operations S110 to S160 described above with reference to FIG. 1.

Referring to FIG. 5A, the layout builder may display a screen to select a category for building the customized layout. According to an example embodiment, the administrator may select a layout category, from among a plurality of layout categories provided in a scroll down menu. According to an example embodiment, the layout categories may identify layouts for different types of application platforms. For instance, a first layout category of the layout categories may indicate a B2B application platform for business to business (B2B) application platform and a second layout category of the layout categories may indicate a B2C application platform for business to customer (B2C) application platform. However, the disclosure is not limited to the B2B and B2C application platforms, and as such, other categories may indicate layouts of other application platform supported by the business enterprise.

According to an example embodiment, in addition to selecting a category, the operator or a user may select an application, from among a different types of application. According to an example embodiment, the category may be a subset of an application selected for providing the customized layout. According to an example embodiment, the operator or the user may input a template name to identify the customized layout created using the process of the disclosure.

Referring to FIG. 5B, based on the category selected by the operator or the user, the layout builder may output a screen showing all the components 500 available for the application and the category selected by the user. For example, the components 500 may include summary, order, billing, etc. Moreover, the components 500 may further include sub-components 500-1, such as billing account, bills, payment, etc., which are under billing and customer information, which is under summary. According to an example, embodiment, the operator or the user may select any of the components 500 or the sub-components to be part of the customized layout. Although, summary, order, billing, are shown as components, the disclosure is not limited thereto, and as such, according to other example embodiments, various other components may be provided.

FIG. 5C illustrates a view of a layout builder screen, in which, the operator or the user selects a tab from the layout elements provided in a first region 510 of the layout builder screen and places the tab into a second region of the layout builder screen. According to an example embodiment, the operator or the user may able to name the tab in accordance with a preference of the operator or the user. For example, as shown in FIG. 5D, the tab in the second region may be labeled as “Overview”. Although a layout using tabs are illustrated in FIG. 5C, according to another example embodiment, the layout maybe provided using a tree hierarch structure to display information.

FIG. 5D illustrates a view of a layout builder screen, in which, the operator or the user selects a “customer” component from the components available in the first region 510 of the layout builder screen and places the tab into the second region 520 of the layout builder screen. According to an example embodiment, the operator or the user may click, drag and drop the “customer” component to the second region 520. As shown in FIG. 5G, the “customer” component may provide customer information 530 corresponding to a customer identification information.

FIGS. 5E and 5F illustrate views of a layout builder screen, in which, the operator or the user assigns a role to the customized layout. According to an example embodiment, the operator or the user may click, drag and drop the “viewer” role from the available roles region to the selected roles region.

FIG. 5G illustrates a view of a customized layout according to an example embodiment. As shown in FIG. 5G, the “customer” component may provide customer information 530 corresponding to a customer identification information, an order component may provide order information 540 corresponding to the customer identification information, and the billing account information may provide billing information 550 corresponding to the customer identification information.

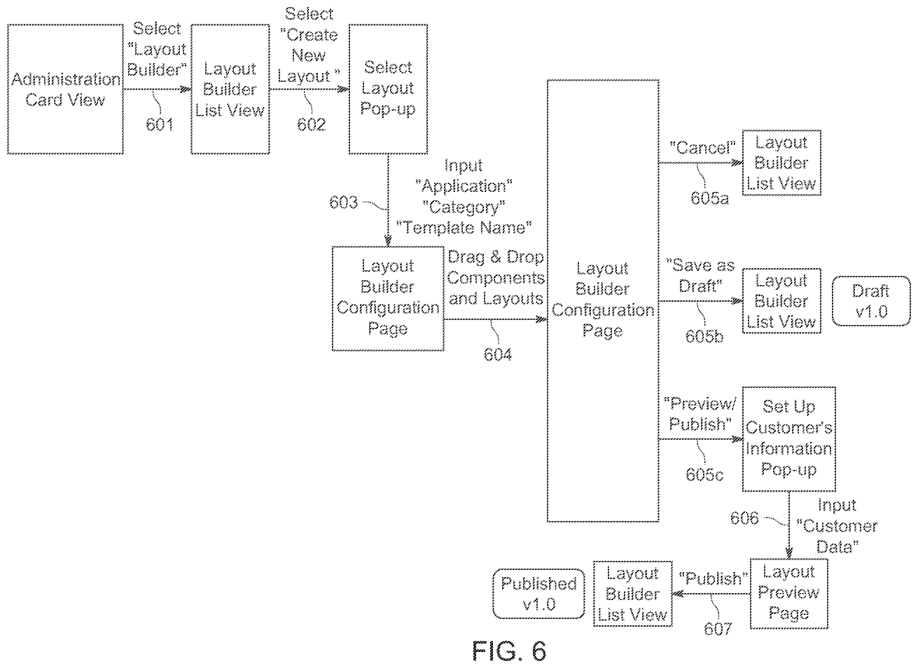

FIG. 6 is a flowchart of an example process for creating a customized layout, according to an example embodiment. According to an example embodiment, in 601, a user may select a layout builder in an application platform. According to an example embodiment, the application platform may be an administrator authorized application platform, and the user may be an administrator. According to an example embodiment, based on the user selecting a layout builder, output a layout builder list view. In 602, the user may select to create a new layout from the options in the layout builder list view, and a layout pop-up screen may be provided as shown in FIG. 5A. In 603, the user may input application information, category information and template name, and the layout builder may display a layout builder configuration page. According to an example embodiment, the layout builder configuration page may be a layout builder scree illustrated in FIGS. 5B-5D above.

According to an example embodiment, in 604, the user may select, drag and drop components from a library region of the layout builder configuration page to a layout region of the layout builder configuration page. After selecting the components, the user may cancel (605a), save as draft (605b) or preview/publish the layout (605c). In 606, the user may input customer information to preview the layout (see FIG. 5G), and in 607, the user may publish the layout. According to an example embodiment, the user may map one or more roles to the layout. According to an example embodiment, the one or more roles may be mapped before or after the layout is published.

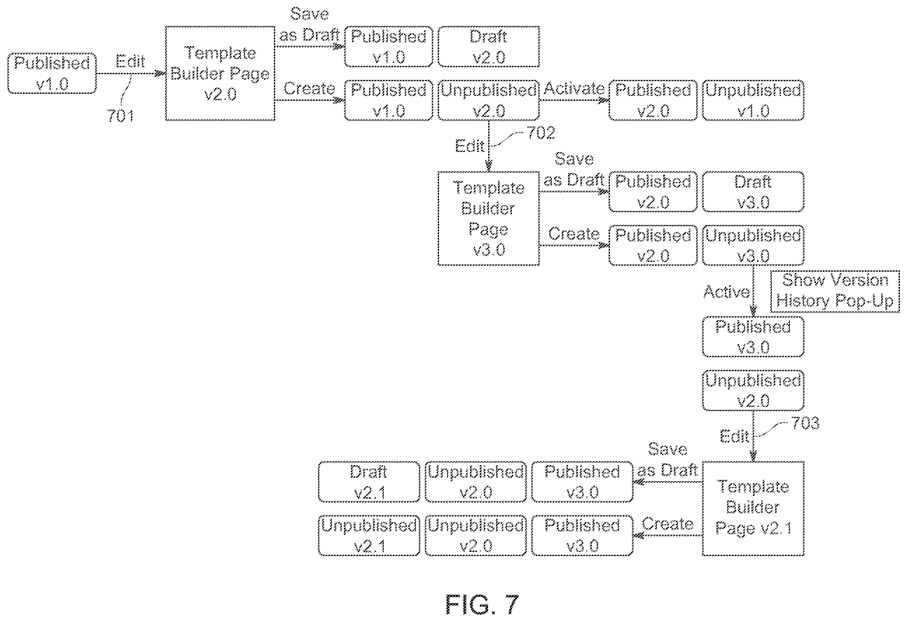

FIG. 7 is a flowchart of an example process for editing a published layout, according to an example embodiment.

Referring to FIG. 7, according to an example embodiment, when a published v 1.0 layout is selected to be edited (701), the layout builder page v 2.0 may save the v 2.0 layout as a draft v 2.0 or create an unpublished v 2.0. According to an example embodiment, when the unpublished v 2.0 layout is activated to be published, the v 1.0 layout becomes unpublished and the v 2.0 layout becomes published.

According to an example embodiment, the unpublished v 2.0 layout is selected to be edited (702), the layout builder page v 3.0 may save the v 3.0 layout as a draft v 3.0 or create an unpublished v 3.0. According to an embodiment, when the unpublished v 3.0 layout is activated to be published, the v 2.0 layout is unpublished and the v 3.0 layout becomes published.

According to an example embodiment, the unpublished v 2.0 layout is selected to be edited while the v 3.0 layout is published (703), the layout builder page v 2.1 may save the v 2.1 layout as a draft v 2.1 or create an unpublished v 2.1.

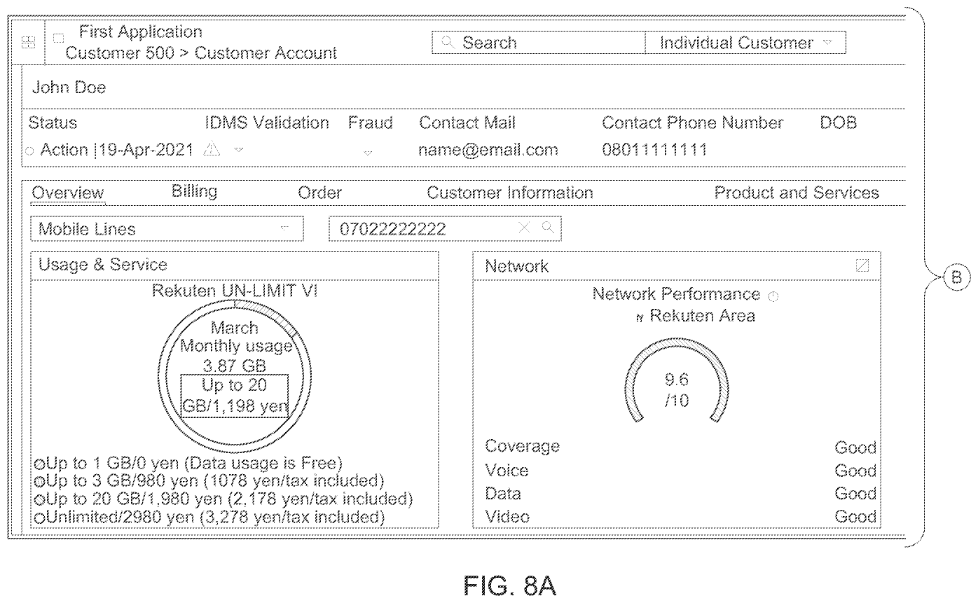

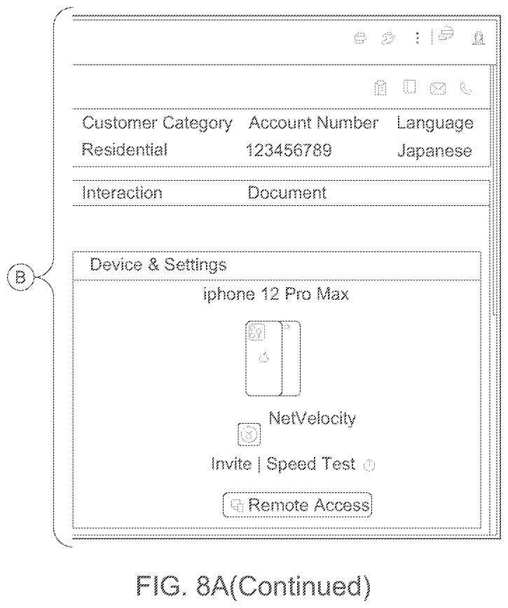

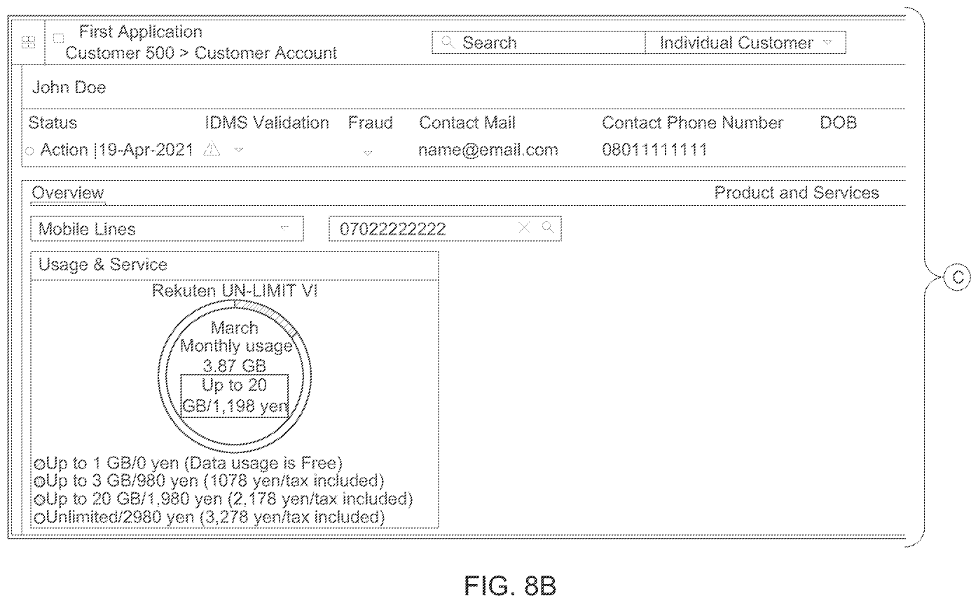

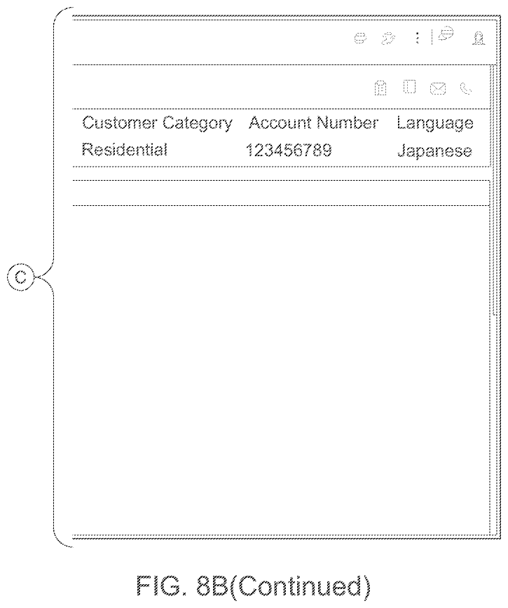

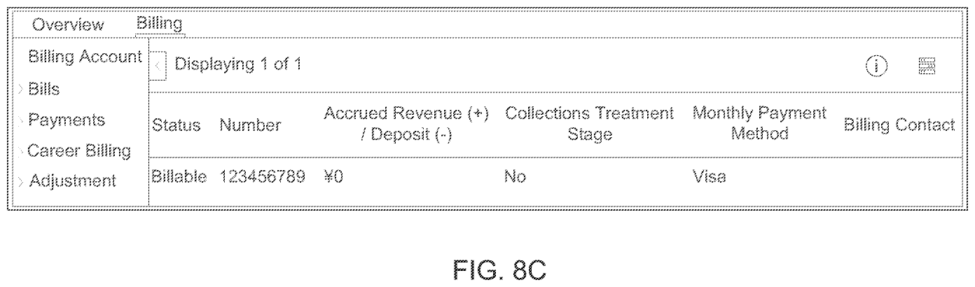

FIG. 8A illustrates an example of a default layout for presenting information; and FIGS. 8B and 8C illustrate examples of customized layout for presenting information, according to an example embodiment.

For example, in FIG. 8A, a graphical user interface (GUI) screen corresponding to a default layout is shown, in which, information related to usage and services, information related to network and information related to device and settings are displayed in an integrated manner on a single viewing window. Moreover, in FIG. 8A, the tabs for “Billing”, “Order”, “Customer Information”, “Products and Services”, “Interaction” and “Document” are included in the default layout.

On the other hand, FIGS. 8B and 8C illustrate examples of customized layout for presenting information, according to an example embodiment. For example, in FIG. 8B, based on the operator having a first role, “Overview” information and “Products and Services” information is provided in the customized layout. That is, the tabs corresponding to the “Billing”, “Order”, “Customer Information”, “Interaction” and “Document” are omitted in the customized layout in FIG. 8B.

In FIG. 8B, based on the operator having a second role, “Overview” information and “Billing” information is provided in the customized layout. That is, the tabs corresponding to the “Order”, “Customer Information”, “Products and Services”, “Interaction” and “Document” are omitted in the customized layout in FIG. 8C.

According to an aspect of the disclosure as illustrated according to an example embodiment in FIGS. 8B and 8C, instead of an agent having to view various information not relevant to their role, a customized layout is provided to the agent in a streamlined manner. As a result, time for reviewing data is reduced, computing resources such as power consumption, processor requirement and memory requirement are reduced, user convenience is increased, and network resources are conserved.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein

What is claimed is:

1. A method of providing a customized layout in an integrated presentation system, the method comprising:
outputting a list including a plurality of components in a first region of a layout builder screen, each of the plurality of components corresponding to one of a plurality of applications;
based on receiving a component selection input including one or more components, among the plurality of components, from the list, displaying the one or more components in one or more areas in a second region of the layout builder screen;
creating the customized layout based on the one or more components in the one or more areas in the second region of the layout builder screen; and
mapping the customized layout with one or more roles, among a plurality of roles associated with a user of the integrated presentation system.

2. The method according to claim 1, wherein the component selection input comprises at least one of dragging the one or more components from the first region and dropping the one or more components into the second region, changing a size of the one or more components, by dragging an edge of the one or more components, or moving the one or more components within the second region.

3. The method according to claim 1, wherein the receiving the component selection input including the one or more components comprises:
receiving a first selection including a first component, among the plurality of components from the list, the first component configured to display first data from a first application, among the plurality of applications; and
receiving a second selection including a second component, among the plurality of components from the list, the second component configured to display second data from a second application, among the plurality of applications.

4. The method according to claim 3, wherein the displaying the one or more components comprises:
displaying the first component in a first area in the second region of the layout builder screen; and
displaying the second component in a second area in the second region of the layout builder screen.

5. The method according to claim 1, further comprises:
receiving a category selection input indicating a category corresponding to an application platform, among a plurality of categories of application platform; and
outputting the list including the plurality of components based on the category selection input.

6. The method according to claim 5, further comprises:
publishing the customized layout to deploy the customized layout on the application platform.

7. An apparatus for providing a customized layout in an integrated presentation system, the apparatus comprising:
a memory storing instructions; and
at least one processor configured to execute the instructions to:
output a list including a plurality of components in a first region of a layout builder screen, each of the plurality of components corresponding to one of a plurality of applications;
based on receiving a component selection input including one or more components, among the plurality of components, from the list, display the one or more components in one or more areas in a second region of the layout builder screen;
create the customized layout based on the one or more components in the one or more areas in the second region of the layout builder screen; and
map the customized layout with one or more roles, among a plurality of roles associated with a user of the integrated presentation system.

8. The apparatus according to claim 7, wherein the component selection input comprises at least one of dragging the one or more components from the first region and dropping the one or more components into the second region, changing a size of the one or more components, by dragging an edge of the one or more components, or moving the one or more components within the second region.

9. The apparatus according to claim 7, wherein the processor is further configured to:
receive a first selection including a first component, among the plurality of components from the list, the first component configured to display first data from a first application, among the plurality of applications; and
receive a second selection including a second component, among the plurality of components from the list, the second component configured to display second data from a second application, among the plurality of applications.

10. The apparatus according to claim 9, wherein the processor is further configured to:
display the first component in a first area in the second region of the layout builder screen; and
display the second component in a second area in the second region of the layout builder screen.

11. The apparatus according to claim 7, wherein the processor is further configured to:
receive a category selection input indicating a category corresponding to an application platform, among a plurality of categories of application platform; and
output the list including the plurality of components based on the category selection input.

12. The apparatus according to claim 11, wherein the processor is further configured to:
publish the customized layout to deploy the customized layout on the application platform.

13. A non-transitory computer readable medium having stored thereon a program from performing a method of providing a customized layout in an integrated presentation system, the method comprising:
outputting a list including a plurality of components in a first region of a layout builder screen, each of the plurality of components corresponding to one of a plurality of applications;
based on receiving a component selection input including one or more components, among the plurality of components, from the list, displaying the one or more components in one or more areas in a second region of the layout builder screen;
creating the customized layout based on the one or more components in the one or more areas in the second region of the layout builder screen; and
mapping the customized layout with one or more roles, among a plurality of roles associated with a user of the integrated presentation system.

14. The non-transitory computer readable medium according to claim 13, wherein the component selection input comprises at least one of dragging the one or more components from the first region and dropping the one or more components into the second region, changing a size of the one or more components, by dragging an edge of the one or more components, or moving the one or more components within the second region.

15. The non-transitory computer readable medium according to claim 13, wherein the receiving the component selection input including the one or more components comprises:
receiving a first selection including a first component, among the plurality of components from the list, the first component configured to display first data from a first application, among the plurality of applications; and
receiving a second selection including a second component, among the plurality of components from the list, the second component configured to display second data from a second application, among the plurality of applications.

16. The non-transitory computer readable medium according to claim 15, wherein the displaying the one or more components comprises:
displaying the first component in a first area in the second region of the layout builder screen; and
displaying the second component in a second area in the second region of the layout builder screen.

17. The non-transitory computer readable medium according to claim 13, further comprises:
receiving a category selection input indicating a category corresponding to an application platform, among a plurality of categories of application platform; and
outputting the list including the plurality of components based on the category selection input.

18. The non-transitory computer readable medium according to claim 17, further comprises:
publishing the customized layout to deploy the customized layout on the application platform.

19. A method of providing information for a user in an integrated presentation system, the method comprising:
receiving user identification information from an operator of an integrated presentation system;
controlling, based on a role associated with the operator, to output a customized graphical user interface (GUI) to present information related to the user identification information;
sending a plurality of parameters to a server, the plurality of parameters including first information corresponding to a first application, second information corresponding to a second application, and third information corresponding to one or more identifying parameters from the user identification information;
receiving first data associated with the user identification information from the first application and second data associated with the user identification information from the second application; and
controlling to output the first data and the second data in the GUI in an integrated manner based on the role associated with the operator.

20. An apparatus for providing information for a user in an integrated presentation system, the apparatus comprising:
a memory storing instructions; and
at least one processor configured to execute the instructions to:
receive user identification information from an operator of an integrated presentation system;
control, based on a role associated with the operator, to output a customized graphical user interface (GUI) to present information related to the user identification information;
send a plurality of parameters to a server, the plurality of parameters including first information corresponding to a first application, second information corresponding to a second application, and third information corresponding to one or more identifying parameters from the user identification information;
receive first data associated with the user identification information from the first application and second data associated with the user identification information from the second application; and
control to output the first data and the second data in the GUI in an integrated manner based on the role associated with the operator.
